(19) United States
(12) Patent Application Publication
(10) Pub. No.: US 2025/0148488 A1
(43) Pub. Date: May 8, 2025

(54) STOCK TREND ANALYSIS METHOD AND APPARATUS BASED ON MACHINE LEARNING

(71) Applicant: SHENZHEN FUTU NETWORK TECHNOLOGY CO., LTD., Shenzhen (CN)

(72) Inventors: Jinhui HU, Shenzhen (CN); Yuyan RU, Shenzhen (CN); Xin XIE, Shenzhen (CN)

(21) Appl. No.: 19/012,915

(22) Filed: Jan. 8, 2025

Related U.S. Application Data
(63) Continuation of application No. PCT/CN2022/111152, filed on Aug. 9, 2022.

(51) Int. Cl. G06Q 30/0202; G06Q 40/04

(52) U.S. Cl. CPC G06Q 30/0202; G06Q 40/04

(57) ABSTRACT

The present application discloses a stock trend analysis method and apparatus based on machine learning, an electronic device, and a storage medium. The method comprises: acquiring a target model and stock data corresponding to a target stock; splitting the target model to obtain a plurality of sub-target models; on the basis of the stock data and the plurality of sub-target models, determining a plurality of trend prediction results corresponding to the target stock; and on the basis of the plurality of trend prediction results, determining a target trend prediction result corresponding to the target stock. According to the present application, the stock data is processed by means of an intelligent model (a target model) to output a trend prediction result corresponding to a target stock, so that the accuracy of the prediction result can be improved.

This application is a continuation of International Patent Application No. PCT/CN2022/111152, filed on Aug. 9, 2022, the entire content of which is incorporated herein by reference.

### FIELD

The present disclosure relates to the technical field of stock analysis, and in particular, to a stock trend analysis method and apparatus based on machine learning, an electronic device, and a storage medium.

### BACKGROUND

Mobile terminals have become a main channel for stock investors to invest in stocks. Applications on the mobile-terminals for stock investment provide the stock investors with technical data on stocks, which is convenient for the stock investors to predict stock trends.

At present, the stock investors mainly use a voting method to predict a stock trend. That is, through interpretation of technical data of the stock (including an index and a pattern corresponding to the stock) by many people, a plurality of trend prediction results are obtained, and a trend prediction result agreed by most people is selected as a final.

However, the stock trend prediction result obtained through the above method is greatly affected by personal understanding, and thus is inaccurate.

### SUMMARY

Embodiments of the present disclosure provide a stock trend analysis method and apparatus based on machine learning, an electronic device, and a storage medium, to improve accuracy of stock trend prediction.

In a first aspect, the embodiments of the present disclosure provide a stock trend analysis method based on machine learning, which is applicable to an electronic device. The method includes: obtaining a target model and stock data corresponding to a target stock, where the stock data is determined based on technical index data and technical morphological data of the target stock; dividing the target model to obtain a plurality of sub-target models; determining a plurality of trend prediction results corresponding to the target stock based on the stock data and the plurality of sub-target models, where the plurality of sub-target models are in one-to-one correspondence with the plurality of trend prediction results; and determining a target trend prediction result corresponding to the target stock based on the plurality of trend prediction results.

In a second aspect, the embodiments of the present disclosure provide a stock trend analysis apparatus based on machine learning. The apparatus includes: a data obtaining module configured to obtain a target model and stock data corresponding to a target stock, where the stock data is determined based on technical index data and technical morphological data of the target stock; a model dividing module configured to divide the target model to obtain a plurality of sub-target models; a trend prediction module configured to determine a plurality of trend prediction results corresponding to the target stock based on the stock data and the plurality of sub-target models, where the plurality of sub-target models are in one-to-one correspondence with the plurality of trend prediction results; and a target trend determination module configured to determine a target trend prediction result corresponding to the target stock based on the plurality of trend prediction results.

In a third aspect, the embodiments of the present disclosure provide an electronic device. The electronic device includes a processor, a memory, a communication interface, and one or more programs. The one or more programs are stored in the memory and configured to be executed by the processor. The programs include instructions for performing steps in the method as described according to the first aspect of the embodiments of the present disclosure.

In a fourth aspect, the embodiments of the present disclosure provide a computer-readable storage medium. The computer-readable storage medium is configured to store a computer program. The computer program is executed by a processor, to implement some or all of the steps described in the method as described according to the first aspect of the embodiments of the present disclosure.

In a fifth aspect, the embodiments of the present disclosure provide a computer program product. The computer program product includes a non-transitory computer-readable storage medium storing a computer program. The computer program is operable, to cause a computer to perform some or all of the steps described in the method as described according to the first aspect of the embodiments of the present disclosure. The computer program product may be a software installation package.

The embodiments of the present disclosure have the following beneficial effects.

The embodiments of the present disclosure provide the stock trend analysis method and apparatus based on machine learning, the electronic device, and the storage medium. The method includes: obtaining the target model and the stock data corresponding to the target stock; dividing the target model to obtain the plurality of sub-target models; determining the plurality of trend prediction results corresponding to the target stock based on the stock data and the plurality of sub-target models; and finally determining the target trend prediction result corresponding to the target stock based on the plurality of trend prediction results. In the present disclosure, the stock data is processed through a data model generated based on the machine learning, to obtain a trend analysis result corresponding to the target stock, which can improve accuracy of the prediction result and provide a user with accurate and sufficient market information.

### BRIEF DESCRIPTION OF THE DRAWINGS

In order to more clearly explain technical solutions of the embodiments of the present disclosure or in the related art, accompanying drawings to be used in the description of the embodiments or in the related art are briefly described below. Obviously, the accompanying drawings as described below are merely some embodiments of the present disclosure. Based on these drawings, other accompanying drawings may be obtained by those of ordinary skill in the art without creative efforts.

FIG. 1 is a schematic structural diagram of an electronic device provided according to an embodiment of the present disclosure.

FIG. 2 is a schematic flowchart illustrating a stock trend analysis method based on machine learning provided according to an embodiment of the present disclosure.

FIG. 3 is a schematic flowchart of obtaining a target model provided according to an embodiment of the present disclosure.

FIG. 4 is a schematic diagram of a technical index interpretation page of Tesla provided according to an embodiment of the present disclosure.

FIG. 5 is a schematic diagram of a technical morphological interpretation page of Tesla provided according to an embodiment of the present disclosure.

FIG. 6 is a schematic flowchart illustrating a stock trend analysis method based on machine learning provided according to another embodiment of the present disclosure.

FIG. 7 is a schematic flowchart illustrating a stock trend analysis method based on machine learning provided according to another embodiment of the present disclosure.

FIG. 8 is a schematic flowchart illustrating model training provided according to an embodiment of the present disclosure.

FIG. 9 is a schematic structural diagram of an electronic device provided according to an embodiment of the present disclosure.

FIG. 10 is a block diagram illustrating composition of functional units of a stock trend analysis apparatus based on machine learning provided according to an embodiment of the present disclosure.

### DETAILED DESCRIPTION

An electronic device may include various handheld devices (mobile phones, tablet computers, and the like) having wireless communication functions, vehicle-mounted devices, wearable devices (such as smart watches and smart glasses), computing devices or other processing devices connected to wireless modems, and various forms of user equipment (UE), mobile stations (MS), virtual reality/augmented reality devices, terminal devices, and the like. The electronic device may also be a server.

The embodiments of the present disclosure are described in detail below.

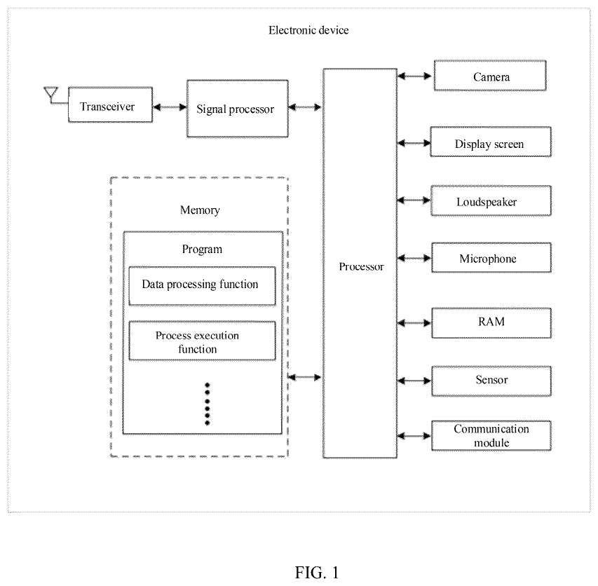

FIG. 1 is a schematic structural diagram of an electronic device provided according to an embodiment of the present disclosure. As illustrated in FIG. 1, the electronic device includes a processor, a memory, a random access memory (RAM), and a display screen. Each of the memory, the RAM, and the display screen is connected to the processor.

Further, the electronic device may include a loudspeaker, a microphone, a camera, a communication interface, a signal processor, and a sensor. Each of the loudspeaker, the microphone, the camera, the signal processor, and the sensor is connected to the processor. The communication interface is connected to the signal processor.

The processor is a control center of the electronic device, connects various parts of the entire electronic device by using various interfaces and lines, executes various functions and data processing of the electronic device by running or executing software programs and/or modules stored in the memory and invoking data stored in the memory, thereby monitoring the electronic device as a whole.

The memory is used for storing a software program and/or module. The processor executes various functional applications and data processing of the electronic device by running the software program and/or module stored in the memory. The memory may mainly include a program storage area and a data storage area. The program storage area may store an operation system, a software program required for at least one function, and the like. The storage data area may store data or the like that is created according to use of the electronic device. In addition, the memory may also include a high-speed random access memory and a non-volatile memory, such as at least one disk storage device, a flash memory device, or other volatile solid-state storage devices.

The electronic device described based on FIG. 1 may be configured to perform the following steps.

A target model and stock data corresponding to a target stock are obtained. The stock data is determined based on technical index data and technical morphological data of the target stock.

The target model is divided to obtain a plurality of sub-target models.

A plurality of trend prediction results corresponding to the target stock are determined based on the stock data and the plurality of sub-target models. The plurality of sub-target models are in one-to-one correspondence with the plurality of trend prediction results.

A target trend prediction result corresponding to the target stock is determined based on the plurality of trend prediction results.

It can be seen that the electronic device described in the embodiments of the present disclosure obtains the target model and the stock data corresponding to the target stock, divides the target model to obtain the plurality of sub-target models, then determines the plurality of trend prediction results corresponding to the target stock based on the stock data and the plurality of sub-target models, and finally determines the target trend prediction result corresponding to the target stock based on the plurality of trend prediction results. In the present disclosure, the stock data is processed through an intelligent model (the target model), to obtain the trend prediction result corresponding to the target stock, which can improve accuracy of the prediction result.

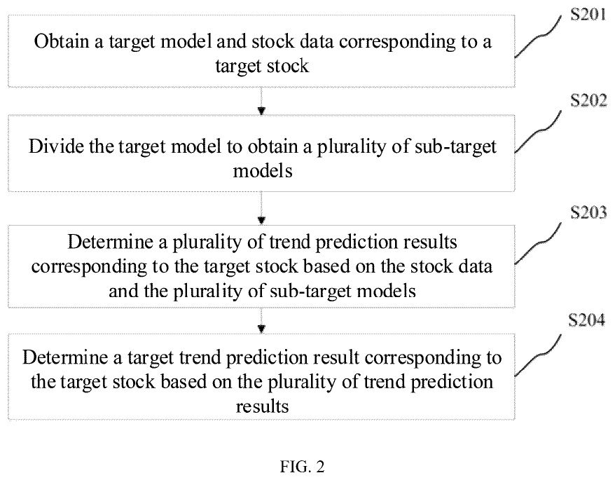

FIG. 2 illustrates a stock trend analysis method based on machine learning provided according to an embodiment of the present disclosure. Referring to FIG. 2, the method is applicable to the electronic device illustrated in FIG. 1, and includes the following steps S201 to S204.

At step S201, a target model and stock data corresponding to a target stock are obtained.

The target model is obtained through training based on a random forest model. A training manner of the random forest model is described below, and its details are omitted herein.

The model in the present disclosure is updated asynchronously, i.e., the model needs to be updated regularly. However, due to limitations of research and development, it is impossible to update the model with each version updating. Therefore, the model needs to be stored in an external storage for hot updating. For example, file data corresponding to the model is stored in an external storage device or a cloud platform, and is updated in real time based on training situations.

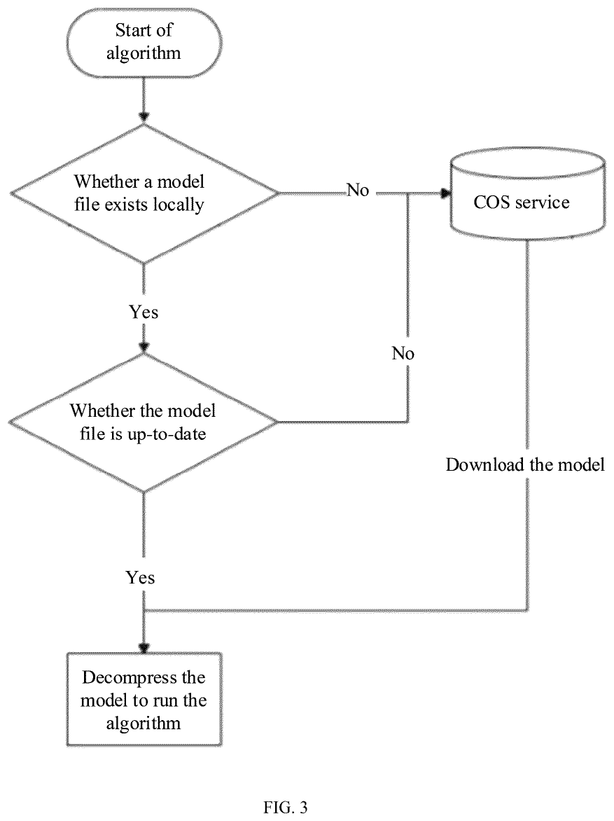

Therefore, the present disclosure adopts a cloud object storage (COS) storage bucket of a public cloud to perform hot-update for the model. As illustrated in FIG. 3, it is pre-detected whether a latest version of the model exists each time before running an algorithm in the background. That is, the target model is obtained through the following three manners. The first manner includes first determining whether a target file corresponding to the target model exists locally to obtain a first determination result, and downloading the target file from the COS storage bucket and decompressing the target file to obtain the target model in response to the first determination result indicating that the target file corresponding to the target model does not exist locally. The second manner includes determining whether the target file corresponding to the target model exists locally to obtain the first determination result, determining whether the target file is the latest version to obtain a second determination result in response to the first determination result indicating that the target file corresponding to the target model exists locally, and obtaining the target model from the target file in response to the second determination result indicating that the target file is the latest version. The third manner includes determining whether the target file corresponding to the target model exists locally to obtain the first determination result, determining whether the target file is the latest version to obtain the second determination result in response to the first determination result indicating that the target file corresponding to the target model exists locally, and downloading the target file from the COS storage bucket and decompressing the target file to obtain the target model in response to the second determination result indicating that the target file is not the latest version.

Based on the above, in response to the target file corresponding to the target model not existing locally, or the local target file corresponding to the target model being not the latest version, a model version may be queried through the COS storage bucket, and the model may be updated. When querying the model update, an MD5 value of the object may be obtained to determine whether the model file is the latest version by performing a comparison query. When needed, a user may directly download the target file from the COS storage bucket and decompress the target file to obtain the target model. In addition, the COS storage bucket also stores and manages respective versions of the model, and the user may directly query past versions of the model through the COS storage bucket. Through the above manner, data redundancy is reduced, and a disaster recovery backup capability of the system is improved.

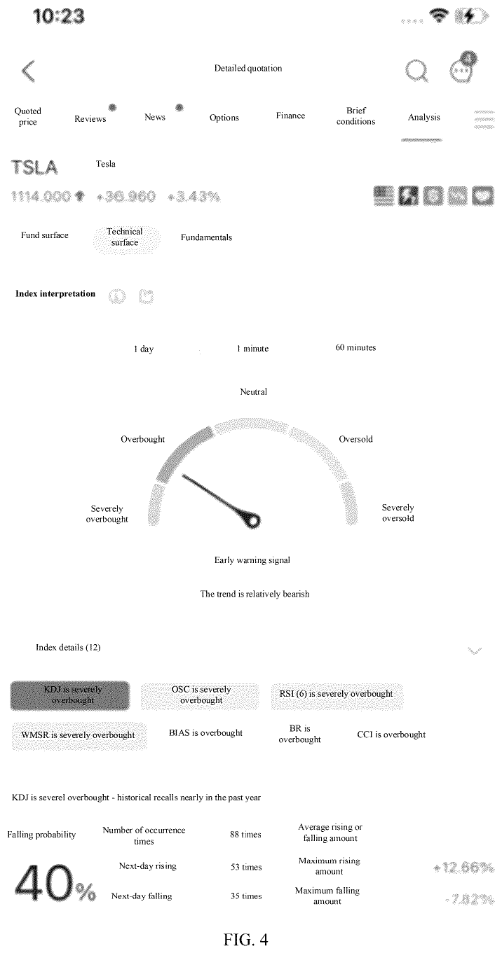

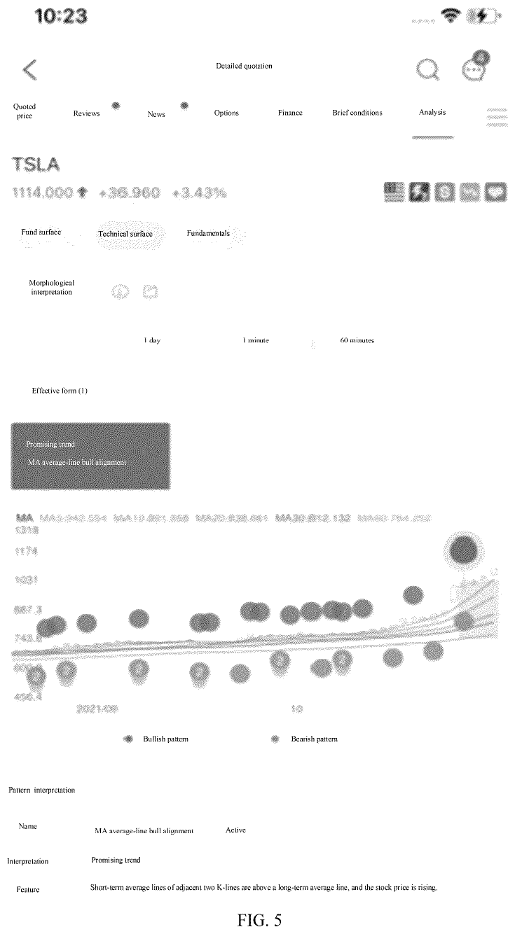

Further, the stock data includes the index data, the morphological data, the label data, and the derivative index that correspond to the target stock. The stock data is determined based on technical index data and technical morphological data of the target stock. The obtaining of the stock data mainly includes the following steps. First, the technical index data and the technical morphological data of the target stock are obtained. For example, through an entrance on an app page of a mobile terminal application, such as Futubull as illustrated in FIG. 4 and FIG. 5, the user directly enters a stock detailed quotation page, and corresponding technical index interpretation and technical morphological interpretation of the target stock (such as Tesla) may be directly displayed through clicking analysis. Through the index interpretation, Tesla's technical index data may be obtained. Through the morphological interpretation, Tesla's technical morphological data may be obtained. Then, the label data and a derivative index corresponding to the target stock are determined based on the index data and the morphological data. Finally, the index data, the morphological data, the label data, and the derivative index are determined as the stock data.

In an embodiment, the index data includes values corresponding to various indexes of the target stock. The morphological data includes a morphological distribution situation of the target stock, such as having or not having a predetermined pattern. The label data includes label values of overbought, severely overbought, oversold, severely oversold, and neutral corresponding to the index data of the target stock. The derivative data includes data formed by coupling of historical data of the index data, morphological data, and label data, such as label values of overbought, severely overbought, oversold, severely oversold, neutral, rising or falling amount, as well as a historical opening price, a historical closing price, and a historical rising or falling amount.

At step S202, the target model is divided to obtain a plurality of sub-target models.

At step S203, a plurality of trend prediction results corresponding to the target stock are determined based on the stock data and the plurality of sub-target models.

At step S204, a target trend prediction result corresponding to the target stock is determined based on the plurality of trend prediction results.

Since the model is trained through the historical data, an old model may be distorted with time, resulting in a decrease in prediction accuracy. Therefore, the model needs to be automatically trained regularly. Meanwhile, the model update should not interfere with a published version and an online main process. Therefore, according to the present disclosure, the model is updated asynchronously.

Before performing trend prediction on the target stock, according to the present disclosure, whether the model is updated needs to be checked. After the target model is obtained in the three manners of the previous embodiment, the target model is divided to obtain the plurality of sub-target models. Then, the trend prediction of the target stock is performed by loading the plurality of sub-target models in batches to obtain the plurality of trend prediction results. The plurality of sub-target models correspond to the plurality of trend prediction results in one-to-one correspondence. The present disclosure adopts a method for loading the target model in batches, which can reduce memory occupation and cost requirements.

In practical applications, an original model takes up too much memory for loading (about 27G) and takes more loading time (averaging around 10 minutes). By deconstructing the model at a algorithmic base layer, a logic code for calculation is rewritten, such that the memory required by the entire algorithm is reduced to about 4G, while its calculation result is basically consistent with that of the original model and has an extremely small error (a maximum error not exceeding ±2.22e-16).

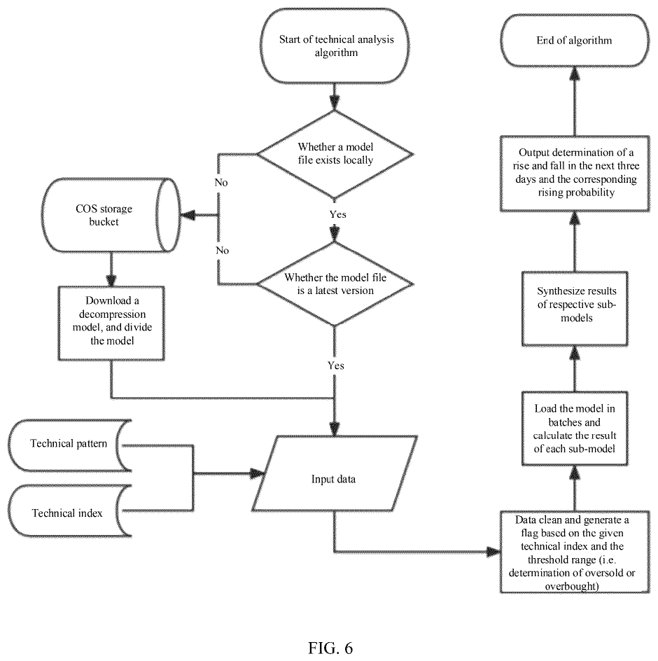

Further, with reference to FIG. 6, the random forest model is taken as an example for the target model, to describe in detail a process of dividing and loading the target model and determining the target trend prediction result corresponding to the target stock based on the target model after the loading and dividing.

When the random forest model is obtained, a quantity of trees in the random forest model is determined to be m, where m is a positive integer. Then, the m trees in the random forest model are divided equally or unequally as required. In response to dividing the m trees into three equal parts as required, three sub-random forest models are obtained, i.e., a first random forest model, a second random forest model, and a third random forest model are obtained. Each of the first random forest model, the second random forest model, and the third random forest model includes m/3 trees.

After the random forest model is divided, the first random forest model, the second random forest model, and the third random forest model may be loaded sequentially, i.e., the stock data is respectively inputted into the first random forest model, the second random forest model, and the third random forest model, to output a first trend prediction result, a second trend prediction result, and a third trend prediction result. Then, the first trend prediction result, the second trend prediction result, and the third trend prediction result are aggregated to obtain the plurality of trend prediction results, and the target trend prediction result corresponding to the target stock is determined based on the plurality of trend prediction results.

Further, after the plurality of trend prediction results are obtained, it is necessary to perform statistical analysis on the plurality of trend prediction results to obtain the target trend prediction result. The statistical analysis includes, but is not limited to average calculation. The target trend prediction result includes a rising-falling trend of the target stock within a predetermined future time period, and a probability corresponding to the rising-falling trend.

Further, after obtaining the trend prediction results based on the respective sub-target models and aggregating the trend prediction results to determine a prediction result, a correlation Con Tre_i, Tar) between eigenvectors Tre_1 corresponding to k trend prediction results and an eigenvector Tar corresponding to the target trend prediction result is calculated as:

$$Con ( Tre\_i , Tar ) = 1 - \frac{\vert α \cdot Tar - β \cdot Tre\_i \vert}{\vert Tar \vert} ,$$

where α and β respectively represent eigenvalues corresponding to the eigenvectors of respective prediction results, i represents an identification corresponding to the sub-target model, and k represents a quantity of the sub-target models. After calculating the correlation Con_i corresponding to each sub-model, the correlation is taken as an accuracy of the sub-model corresponding to the trend prediction result. In addition, accuracies corresponding to respective sub-models are determined as analysis weights of the trend prediction results in a next comprehensive analysis. Then, the corresponding target trend prediction result Tar is obtained as:

$$Tar = {\sum }_{i = 1}^{k} Con\_i \cdot Tre\_i .$$

It should be noted that the eigenvector corresponding to the prediction result in the above formula is a vector sum of the eigenvectors corresponding to the target trend prediction results.

In addition, in an embodiment, a model effect of each sub-model may be evaluated based on the accuracy and the predetermined threshold. When the accuracy is smaller than the predetermined threshold, the sub-model may be trained targetedly to improve the accuracy of the sub-model, thereby improving accuracy of the entire model.

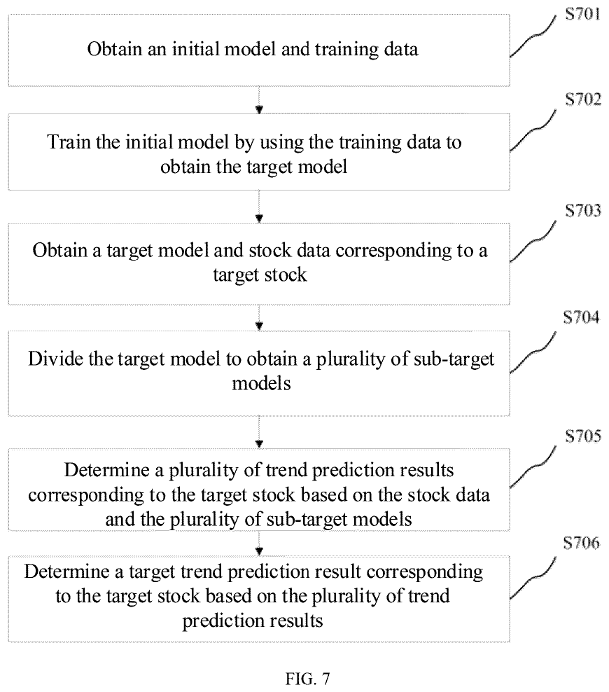

FIG. 7 is a stock trend analysis method based on machine learning provided according to another embodiment of the present disclosure. Referring to FIG. 7, the method is applied to an electronic device illustrated in FIG. 1 and includes the following steps S701 to S706.

At step S701, an initial model and training data are obtained.

The initial model is a random forest model.

The obtaining the training data according to the present disclosure includes the following steps. K-line data is obtained. Then, initial index data and initial morphological data are calculated based on the K-line data. Then, the initial index data and the initial morphological data are cleaned to obtain target index data and target morphological data. Finally, training data is determined based on the target index data and the target morphological data.

The determining the training data based on the target index data and the target morphological data includes: determining label data based on the target index data, the target morphological data, and a first predetermined threshold; coupling the label data and historical data to obtain a derivative index; and aggregating the target index data, the target morphological data, the label data, and the derivative index to obtain the training data.

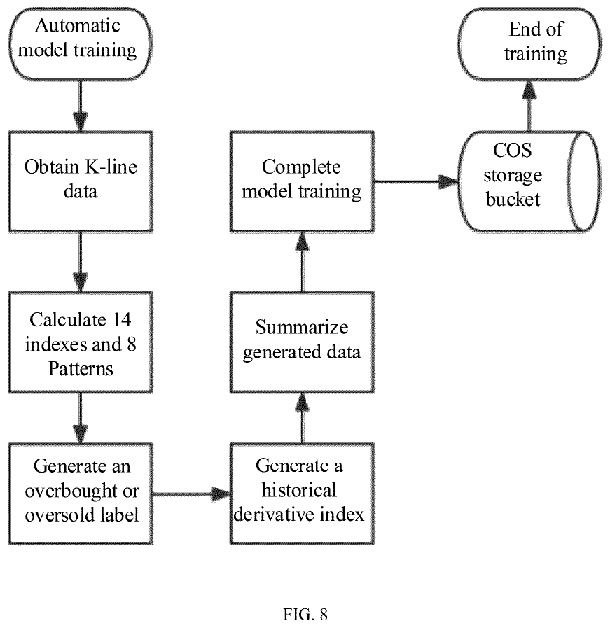

In combination with FIG. 8, the process of obtaining the training data is described in detail. Before training the initial model, the training data needs to be obtained. The training data is obtained in the following manner. The K-line data is obtained, and the initial index data and initial morphological data may be directly calculated through the K-line data, and then the initial index data and initial morphological data are cleaned to obtain 14 pieces of target index data and 8 pieces of target morphological data. A target morphology means that a K-line itself or a derived line generated based on the K-line has a predetermined pattern, such as an intersection point and an extreme point. In this case, these predetermined pattern may be understood as a signal of overbought or oversold. A target index is calculated based on historical values of the K-line. Different from the morphology, the index has a value. Different threshold ranges may be defined for the index based on historical performance of different markets. Indexes within different ranges may be interpreted as seriously oversold, oversold, neutral, severely overbought, overbought, and other conclusions.

Since corresponding label data may be determined for the target index data and the target morphological data based on their own states or value ranges, where the label data characterizes a degree of overbought or oversold indicated by the target index data and the target morphological data, the target index data and the target morphological data may be respectively compared with the first predetermined threshold, and the label data corresponding to the target index data and the target morphological data may be directly determined, i.e., whether the target index data and the target morphological data indicate severely oversold, oversold, neutral, severely overbought or overbought.

When the label data is determined, the derivative index may be obtained based on the coupling of the label data and the historical data. The historical data at least includes a historical opening price, a historical closing price, and a historical rising or falling amount After the target index data, the target morphological data, the label data, and the derivative index are sequentially obtained through the above steps, the target index data, the target morphological data, the label data, and the derivative index are aggregated to obtain the training data.

As can be seen from the above description, in addition to the 14 pieces of target index data and the 8 pieces of target morphological data, the label data in this embodiment further includes forming label values for overbought, severely overbought, oversold, severely oversold, neutral, and the like based on a threshold (i.e., the first predetermined threshold) set for each index and morphology.

In an embodiment, the derivative data further includes historical data such as rising or falling amounts, opening prices, and closing prices in the past three trading days, as well as difference values, rising or falling amounts, and original values of all the 14 pieces of target index data in the past three trading days, totaling 295 different index dimensions. In an embodiment, the overbought or oversold indexes include, but are not limited to, a commodity channel index, a random index, a relative strength index, a William's index, a deviation rate, a willingness index, a trading-volume abnormal variable, a psychological line index, a wobble index, a popularity index, and the like.

At step S702, the initial model is trained by using the training data to obtain the target model.

When the training data is obtained, the training data may be directly inputted into the random forest model, and a hyper parameter in the random forest model may be optimized through grid search, to obtain the target model when the hyper parameter reaches a second predetermined threshold. The hyper parameter may include, but is not limited to, a complexity degree, a highest complexity degree, a highest feature parameter, and the like of the model.

At step S703, a target model and stock data corresponding to a target stock are obtained.

At step S704, the target model is divided to obtain a plurality of sub-target models.

At step S705, a plurality of trend prediction results corresponding to the target stock are determined based on the stock data and the plurality of sub-target models.

At step S706, a target trend prediction result corresponding to the target stock is determined based on the plurality of trend prediction results.

The contents described in steps S703 to S706 are the same as those described in steps S201 to S204, and details are omitted herein.

It can be seen that with the stock trend analysis method based on machine learning described in the embodiments of the present disclosure, the target model and stock data corresponding to the target stock are obtained, the target model is divided to obtain the plurality of sub-target models, then the plurality of trend prediction results corresponding to the target stock are determined based on the stock data and the plurality of sub-target models, and finally the target trend prediction result corresponding to the target stock is determined based on the plurality of trend prediction results. In the present disclosure, the stock data is processed through an intelligent model (the target model), to output the trend prediction result corresponding to the target stock, which can improve accuracy of the prediction result.

It should be understood that the sequence numbers of respective steps in the above embodiments does not mean the sequence of execution, and that the sequence of execution of respective processes should be determined according to its function and internal logic, and should not constitute any limitation to the implementation process of the embodiments of the present disclosure.

The following are apparatus embodiments of the present invention. For details not described in detail, reference can be made to the corresponding method embodiments as described above.

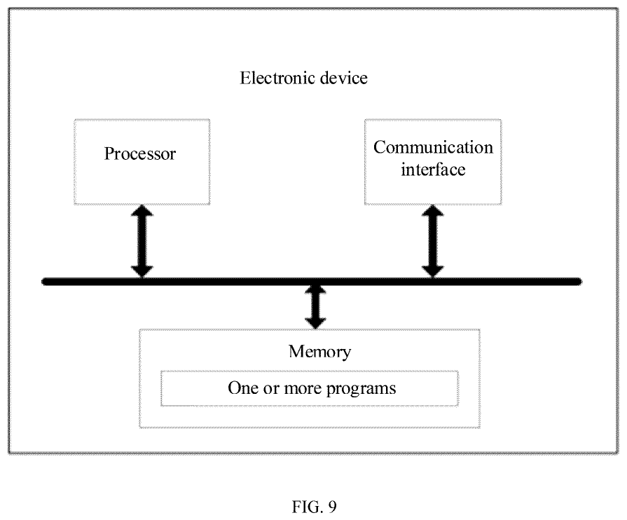

FIG. 9 is a schematic structural diagram of an electronic device provided according to an embodiment of the present disclosure. Referring to FIG. 9, the electronic device includes a processor, a memory, a communication interface, and one or more programs. The one or more programs are stored in the memory and configured to be executed by the processor. The programs include instructions for performing steps corresponding to the method in FIG. 1, and details are omitted herein.

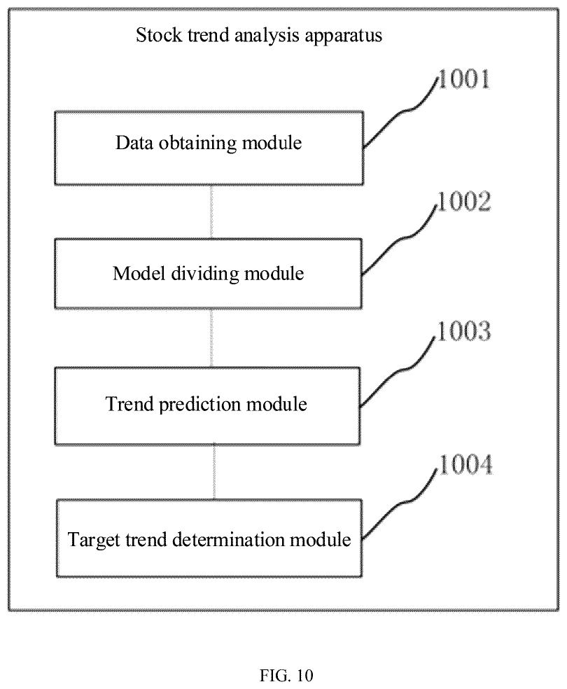

FIG. 10 is a stock trend analysis apparatus based on machine learning provided according to an embodiment of the present disclosure. Referring to FIG. 10, the apparatus is applicable to an electronic device, and includes a data obtaining module 1001, a model dividing module 1002, a trend prediction module 1003, and a target trend determination module 1004.

The data obtaining module 1001 is configured to obtain a target model and stock data corresponding to a target stock. The stock data is determined based on technical index data and technical morphological data of the target stock.

The model dividing module 1002 is configured to divide the target model to obtain a plurality of sub-target models.

The trend prediction module 1003 is configured to determine a plurality of trend prediction results corresponding to the target stock based on the stock data and the plurality of sub-target models. The plurality of sub-target models are in one-to-one correspondence with the plurality of trend prediction results.

The target trend determination module 1004 is configured to determine a target trend prediction result corresponding to the target stock based on the plurality of trend prediction results.

In an embodiment, the data obtaining module 1001 includes: a first determination sub-module configured to determine whether a target file corresponding to the target model exists locally to obtain a first determination result; and a first decision sub-module configured to obtain the target model based on the first determination result.

In an embodiment, the first decision sub-module includes: a first decision unit configured to, in response to the first determination result indicating that the target file corresponding to the target model does not exist locally, download the target file from a COS storage bucket, and decompress the target file to obtain the target model.

In an embodiment, the first decision unit includes: a first determination sub-unit configured to, in response to the first determination result indicating that the target file corresponding to the target model exists locally, determine whether the target file is a latest version to obtain a second determination result; and a first decision sub-unit configured to obtain, in response to the second determination result indicating that the target file is the latest version, the target model from the target file.

In an embodiment, the first decision sub-module includes: a second decision unit configured to, in response to the second determination result indicating that the target file is not the latest version, download the target file from a COS storage bucket and decompress the target file to obtain the target model.

In an embodiment, the data obtaining module 1001 includes: a data obtaining sub-module configured to obtain the technical index data and the technical morphological data of the target stock; a data generation sub-module configured to determine, based on the index data and the morphological data, label data and a derivative index that correspond to the target stock; and a stock data determination sub-module configured to determine the index data, the morphological data, the label data, and the derivative index as the stock data.

In an embodiment, the trend prediction module 1003 includes: a model processing sub-module configured to input, for each of the plurality of sub-target models, the stock data into the sub-target model to obtain a trend prediction result corresponding to the sub-target model; and a trend prediction sub-module configured to aggregate respective trend prediction results corresponding to the plurality of sub-target models to obtain the plurality of trend prediction results.

In an embodiment, the target trend determination module 1004 includes: a target trend determination sub-module configured to perform statistical analysis on the plurality of trend prediction results to obtain the target trend prediction result. The target trend prediction result includes a rising-falling trend of the target stock within a predetermined future time period, and a probability corresponding to the rising-falling trend.

In an embodiment, the apparatus further includes, before the data obtaining module 1001, a model obtaining module configured to obtain an initial model and training data, where the initial model is a random forest model; and a model training module configured to train the initial model by using the training data to obtain the target model.

In an embodiment, the model obtaining module includes: a data obtaining sub-module configured to obtain K-line data; an index calculation sub-module configured to calculate initial index data and initial morphological data based on the K-line data; a data cleaning sub-module configured to clean the initial index data and the initial morphological data to obtain target index data and target morphological data; and a training data obtaining sub-module configured to determine the training data based on the target index data and the target morphological data.

In an embodiment, the training data obtaining sub-module includes: a label data determination unit configured to determine label data based on the target index data, the target morphological data, and a first predetermined threshold, where the label data characterizes a degree of overbought or oversold indicated by each of the target index data and the target morphological data; a derivative index determination unit configured to couple the label data and historical data to obtain a derivative index, where the historical data at least comprises a historical opening price, a historical closing price, and a historical rising or falling amount; and a training data obtaining unit configured to aggregate the target index data, the target morphological data, the label data, and the derivative index to obtain the training data.

In an embodiment, the model training module includes: a data input sub-module configured to input the training data into the random forest model and optimize a hyper parameter in the random forest model through grid search; and a target model determination sub-module configured to obtain, in response to the hyper parameter reaching a second predetermined threshold, the target model.

It can be seen that the stock trend analysis apparatus based on machine learning as described in the embodiments of the present disclosure is applied to the electronic device. The target model and the stock data corresponding to the target stock are obtained. The target model is divided to obtain the plurality of sub-target models. The plurality of trend prediction results corresponding to the target stock are determined based on the stock data and the plurality of sub-target models. The target trend prediction result corresponding to the target stock is determined based on the plurality of trend prediction results. The stock data is processed through the intelligent model (the target model), to output the trend prediction result corresponding to the target stock, which can improve the accuracy of the prediction result.

It can be understood that a function of each program module of the stock trend analysis apparatus based on machine learning of this embodiment may be specifically implemented according to the method in the above-described method embodiments, and its specific implementation process may refer to related descriptions of the above-described method embodiments, and details are omitted herein.

The embodiments of the present disclosure further provide a computer-readable storage medium. The computer-readable storage medium stores a computer program for electronic data exchange. The computer program causes a computer to perform some or all of steps performed by the electronic device described in to the above method embodiments.

The embodiments of the present disclosure further provide a computer program product. The computer program product includes a non-transitory computer-readable storage medium storing a computer program. The computer program is operable, to cause a computer to perform some or all of the steps performed by the electronic device described in the above method embodiments. The computer program product may be a software installation package.

The steps of the method or algorithm described in the embodiments of the present disclosure may be implemented by hardware or in a manner where a processor executes a software instruction. The software instruction may consist of a corresponding software module. The software module may be stored in a random access memory (RAM), a flash memory, a read only memory (ROM), an erasable programmable ROM (EPROM), an electrically EEPROM (EEPROM), a register, a hard disk, a removable hard disk, a CD-ROM, or any other form of storage medium known in the art. An exemplary storage medium is coupled to the processor, allowing the processor to read information from the storage medium and write information into the storage medium. Of course, the storage medium may also be a constituent part of the processor. The processor and the storage medium may be located in an ASIC. In addition, the ASIC may be located in an access network device, a target network device, or a core network device. Of course, the processor and the storage medium may also occur in the access network device, the target network device, or the core network device as discrete components.

Those skilled in the art should be aware that in one or more of the above examples, the functions described in the embodiments of the present disclosure may be implemented in whole or in part by software, hardware, firmware, or any combination thereof. When implemented using software, the functions may be implemented in whole or in part in the form of a computer program product. The computer program product includes one or more computer instructions. When the computer program instruction is loaded and executed on the computer, all or part of the processes or functions described in the embodiments of the present disclosure are generated. The computer may be a general purpose computer, a special purpose computer, a computer network, or other programmable devices. The computer instructions may be stored in the computer-readable storage medium or transferred from a computer-readable storage medium to another computer-readable storage medium. For example, the computer instruction may be transmitted from a website site, computer, server or data center to another website site, computer, server or data center in a wired manner (for example, through a coaxial cable, fiber optic, and digital subscriber line (DSL)) or a wireless manner (for example, through infrared, wireless, and microwave). The computer-readable storage medium may be any available medium accessible by the computer or a data storage device such as a server, a data center, or the like that includes one or more available medium integrations. The available medium may be a magnetic medium (such as a floppy disk, a hard disk, and a magnetic tape), an optical medium (such as a digital video disc (DVD)), or a semiconductor medium (such as a solid state disk (SSD)), and the like.

In the above-described specific implementations, the purpose, technical solutions, and beneficial effects of the embodiments of the present disclosure are further described in detail. It should be understood that the above-described implementations are merely specific implementations of the embodiments of the present disclosure, rather than be intended to limit the protection scope of the embodiments of the present disclosure. Any modifications, equivalent substitutions, improvements, and the like made on the basis of the technical solutions of the embodiments of the present disclosure should each be included within the protection scope of the embodiments of the present disclosure.

What is claimed is:

1. A stock trend analysis method based on machine learning, applicable to an electronic device, the method comprising:
obtaining a target model and stock data corresponding to a target stock, wherein the stock data is determined based on technical index data and technical morphological data of the target stock, the target model is hot-updated through a cloud object storage (COS) bucket of a public cloud, the COS bucket of the public cloud stores an MD5 value of the target model, and whether the target model is to be hot-updated is determined based on the MD5 value;
dividing the target model to obtain a plurality of sub-target models;
determining a plurality of trend prediction results corresponding to the target stock based on the stock data and the plurality of sub-target models, wherein the plurality of sub-target models are in one-to-one correspondence with the plurality of trend prediction results; and
determining a target trend prediction result corresponding to the target stock based on the plurality of trend prediction results.

2. The method according to claim 1, wherein the obtaining the target model comprises:
determining whether a target file corresponding to the target model exists locally to obtain a first determination result; and
obtaining the target model based on the first determination result.

3. The method according to claim 2, wherein the obtaining the target model based on the first determination result comprises:
in response to the first determination result indicating that the target file corresponding to the target model does not exist locally, downloading the target file from an object storage bucket, and decompressing the target file to obtain the target model.

4. The method according to claim 2, wherein the obtaining the target model based on the first determination result comprises:
in response to the first determination result indicating that the target file corresponding to the target model exists locally, determining whether the target file is a latest version to obtain a second determination result; and
in response to the second determination result indicating that the target file is the latest version, obtaining the target model from the target file.

5. The method according to claim 4, wherein the obtaining the target model based on the first determination result comprises:
in response to the second determination result indicating that the target file is not the latest version, downloading the target file from an object storage bucket and decompressing the target file to obtain the target model.

6. The method according to claim 1, wherein the obtaining the stock data corresponding to the target stock comprises:
obtaining the technical index data and the technical morphological data of the target stock;
determining, based on the index data and the morphological data, label data and a derivative index that correspond to the target stock; and
determining the index data, the morphological data, the label data, and the derivative index as the stock data.

7. The method according to claim 1, wherein the determining the plurality of trend prediction results corresponding to the target stock based on the stock data and the plurality of sub-target models comprises:
inputting, for each of the plurality of sub-target models, the stock data into the sub-target model to obtain a trend prediction result corresponding to the sub-target model; and
aggregating respective trend prediction results corresponding to the plurality of sub-target models to obtain the plurality of trend prediction results.

8. The method according to claim 1, wherein the determining the target trend prediction result corresponding to the target stock based on the plurality of trend prediction results comprises:
performing statistical analysis on the plurality of trend prediction results to obtain the target trend prediction result, wherein the target trend prediction result comprises a rising-falling trend of the target stock within a predetermined future time period, and a probability corresponding to the rising-falling trend.

9. The method according to claim 1, further comprising, prior to the obtaining the target model and the stock data corresponding to the target stock:
obtaining an initial model and training data, wherein the initial model is a random forest model; and
training the initial model by using the training data to obtain the target model.

10. The method according to claim 9, wherein the obtaining the training data comprises:
obtaining K-line data;
calculating initial index data and initial morphological data based on the K-line data;
cleaning the initial index data and the initial morphological data to obtain target index data and target morphological data; and
determining the training data based on the target index data and the target morphological data.

11. The method according to claim 10, wherein the determining the training data based on the target index data and the target morphological data comprises:
determining label data based on the target index data, the target morphological data, and a first predetermined threshold, wherein the label data characterizes a degree of overbought or oversold indicated by the target index data and the target morphological data;
coupling the label data and historical data to obtain a derivative index, wherein the historical data at least comprises a historical opening price, a historical closing price, and a historical rising or falling amount; and
aggregating the target index data, the target morphological data, the label data, and the derivative index to obtain the training data.

12. The method according to claim 11, wherein the training the initial model by using the training data to obtain the target model comprises:
inputting the training data into the random forest model and optimizing a hyper parameter in the random forest model through grid search; and
in response to the hyper parameter reaching a second predetermined threshold, obtaining the target model.

13. An electronic device, comprising:
a processor;
a memory;
a communication interface; and
one or more programs stored in the memory and configured to be executed by the processor, the programs comprising instructions for performing a stock trend analysis method based on machine learning, the method comprising:
obtaining a target model and stock data corresponding to a target stock, wherein the stock data is determined based on technical index data and technical morphological data of the target stock, the target model is hot-updated through a cloud object storage (COS) bucket of a public cloud, the COS bucket of the public cloud stores an MD5 value of the target model, and whether the target model is to be hot-updated is determined based on the MD5 value;
dividing the target model to obtain a plurality of sub-target models;
determining a plurality of trend prediction results corresponding to the target stock based on the stock data and the plurality of sub-target models, wherein the plurality of sub-target models are in one-to-one correspondence with the plurality of trend prediction results; and
determining a target trend prediction result corresponding to the target stock based on the plurality of trend prediction results.

14. The electronic device according to claim 13, wherein the obtaining the target model comprises:
determining whether a target file corresponding to the target model exists locally to obtain a first determination result; and
obtaining the target model based on the first determination result.

15. The electronic device according to claim 14, wherein the obtaining the target model based on the first determination result comprises:
in response to the first determination result indicating that the target file corresponding to the target model does not exist locally, downloading the target file from an object storage bucket, and decompressing the target file to obtain the target model.

16. The electronic device according to claim 14, wherein the obtaining the target model based on the first determination result comprises:
in response to the first determination result indicating that the target file corresponding to the target model exists locally, determining whether the target file is a latest version to obtain a second determination result; and
in response to the second determination result indicating that the target file is the latest version, obtaining the target model from the target file.

17. The electronic device according to claim 16, wherein the obtaining the target model based on the first determination result comprises:
in response to the second determination result indicating that the target file is not the latest version, downloading the target file from an object storage bucket and decompressing the target file to obtain the target model.

18. The electronic device according to claim 13, wherein the obtaining the stock data corresponding to the target stock comprises:
obtaining the technical index data and the technical morphological data of the target stock;
determining, based on the index data and the morphological data, label data and a derivative index that correspond to the target stock; and
determining the index data, the morphological data, the label data, and the derivative index as the stock data.

19. The electronic device according to claim 13, wherein the determining the plurality of trend prediction results corresponding to the target stock based on the stock data and the plurality of sub-target models comprises:
inputting, for each of the plurality of sub-target models, the stock data into the sub-target model to obtain a trend prediction result corresponding to the sub-target model; and
aggregating respective trend prediction results corresponding to the plurality of sub-target models to obtain the plurality of trend prediction results.

20. A computer-readable storage medium, configured to store a computer program, wherein the computer program, when executed by a processor, implements a stock trend analysis method based on machine learning, the method comprising:
obtaining a target model and stock data corresponding to a target stock, wherein the stock data is determined based on technical index data and technical morphological data of the target stock, the target model is hot-updated through a COS bucket of a public cloud, the COS bucket of the public cloud stores an MD5 value of the target model, and whether the target model is to be hot-updated is determined based on the MD5 value;
dividing the target model to obtain a plurality of sub-target models;
determining a plurality of trend prediction results corresponding to the target stock based on the stock data and the plurality of sub-target models, wherein the plurality of sub-target models are in one-to-one correspondence with the plurality of trend prediction results; and
determining a target trend prediction result corresponding to the target stock based on the plurality of trend prediction results.
